(19) United States
(12) Patent Application Publication
(10) Pub. No.: US 2011/0085489 A1
(43) Pub. Date: Apr. 14, 2011

(54) SAE APPLICATION FOR MBMS

(76) Inventors: Gunar Rydnell, V Frolunda (SE); Hans Bertil Rönneke, Kungsbacka (SE)

(21) Appl. No.: 12/997,407

(22) PCT Filed: Apr. 29, 2009
(86) PCT No.: PCT/EP09/55220

§ 371 Date: Dec. 10, 2010

Related U.S. Application Data
(60) Provisional application No. 61/060,217, filed on Jun. 10, 2008.

(51) Int. Cl. H04W 40/00

(52) U.S. Cl. 370/312

(57) ABSTRACT

The present solution relates to a method in a first core network gateway (220) for providing multimedia broadcast multicast service “MBMS” in a wireless communication network (100). The network (100) comprises a broadcast multicast service center “BM-SC” (245) node which is arranged to be connected to the first core network gateway (220). The network (100) further comprises a second core network gateway (215) arranged to be connected to the first core network gateway (220). Firstly, the first core network gateway (220) receives a MBMS session request from the BM-SC node (245). Then, the first gateway (220) sends a MBMS session response to the BM-SC node (245). The MBMS session request message is then forwarded to the second core network gateway (215). Finally, the first gateway (220) receives a MBMS session response message from the second core network gateway (215). The MBMS session request and response comprises an information field adapted to MBMS.

### TECHNICAL FIELD

This invention relates generally to multimedia broadcast multicast service (MBMS). More particularly this invention relates to MBMS in a long term evolution (LTE)/evolved packet core (EPC) 3^{rd} generation partnership project (3GPP) network.

### BACKGROUND

In 3^{rd} generation partnership project (3GPP) release 6, multimedia broadcast multicast service (MBMS) was standardized. The MBMS service provides functionality for multicast and broadcast of data to end-users in a 3^{rd} generation (3G) or general packet radio service, packet switched (GPRS PS) network. The MBMS architecture is defined such that by using multicast and broadcast mechanisms, a more effective use of resources is achieved. Some applications provided by operators may be of interest to many end-users simultaneously, such as for example football goals or news transmissions in mobile TV. These may be streaming services or download services. A more resource effective method than just transmitting each packet in parallel to end-users in a point-to-point manner may be to broadcast the packets in a cell, so that all users interested in the service may receive the data in parallel. In this way only one single radio channel needs to be allocated for all users, instead of one channel per user. This saves radio spectrum.

In MBMS, there is a broadcast multicast service centre (BM-SC) node that receives packets from application servers. The BM-SC schedules packets and forwards them to the GPRS network, where the Gateway GPRS Support Node (GGSN) and the Serving GPRS Support Node (SGSN) forwards packets further to the radio network, which transmits packets on the air-interface to the end-users, e.g. user equipments such as mobile telephones, palm pilots etc. Anywhere in the network the packets can be cloned and multicasted to several nodes below, if there are users in more than one underlying branch. The cloning and multicasting in the network is based on users being registered to the MBMS service. In that way, a hierarchical tree structure is maintained in the network where all registered users locations are known.

In 3GPP release 8 the long term evolution (LTE)/evolved packet core (EPC) is standardized. The network protocols in LTE/EPC can be either GPRS Tunnelling Protocol version 2 (GTPv2) or Proxy Mobile Internet Protocol (PMIP) based. In case of PMIP based mobility the S5/S8 interfaces between the serving gateway (SGW) and the packet gateway (PGW) implement PMIP protocols, while other 3GPP access related protocols are GTPv2 based. MBMS is not included in the 3GPP Release 8 network, and the plan is to standardize MBMS for LTE/EPC in Release 9 of 3GPP, starting late 2008. If MBMS becomes a success among end users, it will be a demand for its provision also in LTE networks. It will not be acceptable to downgrade quality or availability, by requiring customers to switch to legacy networks for MBMS service in the future. On the contrary, customers will ask for MBMS grade of service and quality fully on a par with LTE services in general.

### SUMMARY

It is thus an objective of this invention is to propose a mechanism for how multimedia broadcast multicast service (MBMS) service may be provided in a long term evolution (LTE)/evolved packet core (EPC) 3^{rd} generation partnership project (3GPP) network.

Further objects and advantages are evident from the following.

At least one of the above objects is achieved with the methods or arrangements according to the example aspects and embodiments of the solution herein described.

The objectives set forth above are achieved by providing, in a first aspect of the present solution, a method in a first core network gateway for providing MBMS in a wireless communication network. The network comprises a broadcast multicast service center (BM-SC) node arranged to be connected to the first core network gateway. The network further comprises a second core network gateway arranged to be connected to the first core network gateway. First, the first core network gateway receives a MBMS session request from the BM-SC node and sends a MBMS session response back to the BM-SC node. Then, the first core network gateway then forwards the MBMS session request message to the second core network gateway and receives a MBMS session response message from the second core network gateway. The MBMS session request and response comprises an information field adapted to MBMS.

In a second aspect of the present solution there is provided an arrangement in a core network gateway for providing MBMS in a wireless communication network. The core network gateway is comprised in the wireless communication network. The network comprises a BM-SC node arranged to be connected to the first core network gateway. The network further comprises a second core network gateway which is arranged to be connected to the first core network gateway. The core network gateway arrangement comprises a receiver configured to receive a MBMS session request from the BM-SC node and a transmitter which is configured to send a MBMS session response to the BM-SC node. The transmitter is further configured to forward the MBMS session request message to the second core network gateway. The receiver is also configured to receive a MBMS session response message from the second core network gateway. The MBMS session request and response comprises an information field adapted to MBMS.

Since the MBMS functionality may be added to existing EPC nodes in analogy to how it is included in the GPRS nodes a Binding Revocation Indication (BRI) message can be triggered and sent from a packet data network gateway (PGW) and a reply Binding Revocation Acknowledgement (BRA) message can be sent back from the serving gateway (SGW). Together with a new MBMS information element it indicates that the BRI/BRA messages are used in a 3GPP specific way to exchange MBMS session start/stop messages. Thus, MBMS service provides functionality for multicast and broadcast of data to end-users in a 3G or GPRS PS network.

An advantage of the present solution is that it integrates MBMS and SAE LTE/EPC in a simple, quick and cost effective way. The MBMS functionality is available also in the case that S5/S8 interfaces between the PGW and the SGW are IETF based. The solution is based on reuse of 3GPP release 7 functionality in existing nodes, so no new infrastructure investments are needed. In addition, the time to market and the standardization effort needed is unparalleled by overlay architecture solutions.

### BRIEF DESCRIPTION OF THE DRAWINGS

The invention will now be further described in more detail in the following detailed description by reference to the appended drawings illustrating embodiments of the invention and in which:

FIG. 1 is a block diagram illustrating a wireless communication network.

FIG. 2 is a block diagram illustrating the embodiments of the architecture of a SAE/LTE network comprising MBMS functionality.

FIG. 3 is a combined flowchart and signaling diagram illustrating a session start procedure.

FIG. 4 is a combined flowchart and signaling diagram illustrating a session stop procedure.

FIG. 5 is a flowchart illustrating embodiments of a method in a core network gateway.

FIG. 6 is a schematic block diagram illustrating embodiments of a core network gateway arrangement.

### DETAILED DESCRIPTION

Basically, the present solution relates to a mechanism for how multimedia broadcast multicast service (MBMS) may be provided in a long term evolution (LTE)/evolved packet core (EPC) release 8 3^{rd} generation partnership project (3GPP) network with Internet Engineering Task Force (IETF) based protocol, i.e. proxy mobile internet protocol (PMP) based S5/S8 interface.

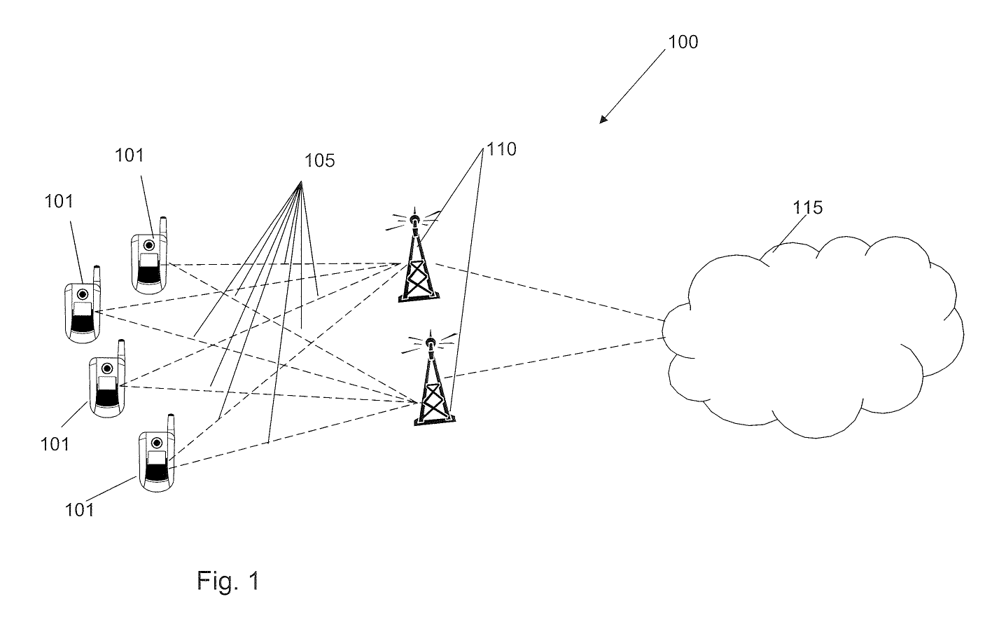

FIG. 1 illustrates a wireless communication system 100 using technologies such as e.g. LTE/EPC (long term evolution/evolved packet core). The wireless communication system 100 comprises user equipments 101 connected to at least one radio access node 110, e.g. base station, eNodeB or RNC. The user equipment 101 may be any suitable communication device or computational device with communication capabilities, for instance but not limited to mobile phone, personal digital assistant (PDA), laptop, MP3 player or portable DVD player (or similar media content devices), digital camera, or even stationary devices such as a PC. A PC may also be connected via a mobile station as the end station of the broadcasted/multicasted media.

The base station 110 is arranged to wirelessly communicate with the user equipment 101 via e.g. radio frequency transmitters and receivers which also may be responsible for transmitting and receiving data over an air interface 105. The base station 110 is connected to a core network 115 providing services to the user equipment 101.

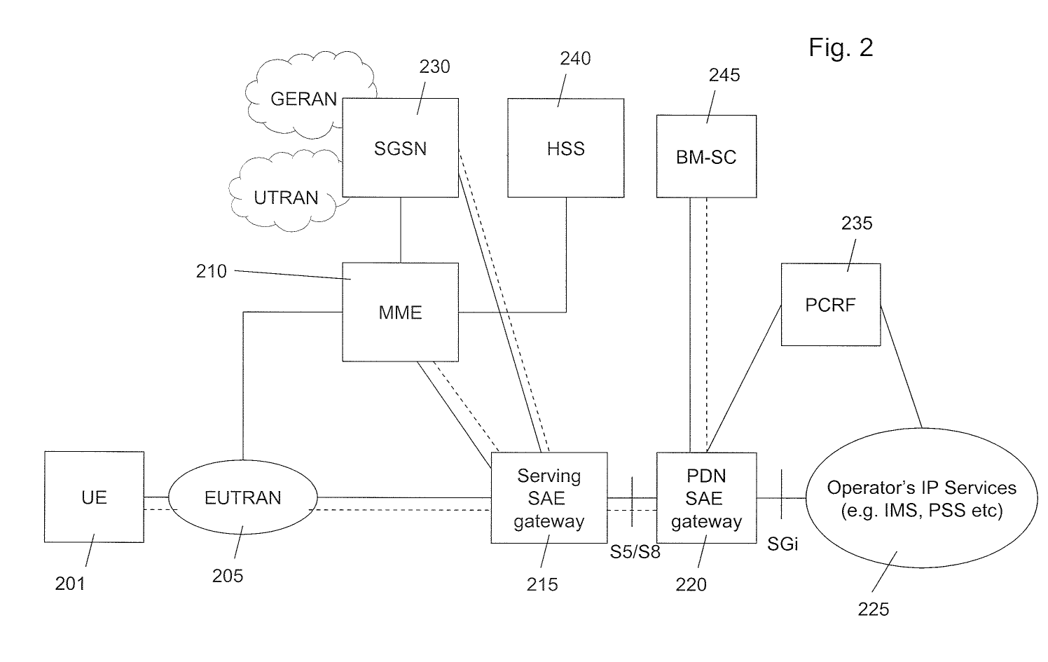

FIG. 2 is a block diagram illustrating the embodiments of the architecture of a SAE/LTE network comprising MBMS functionality. A broadcast multicast service centre (BM-SC) node 245 is added to the existing SAE/LTE network and connected to a packet data network gateway (PGW) 220. The dotted connections show the needed signaling and the solid connections show the payload path for MBMS.

The figure shows a user equipment 201 connected to evolved universal terrestrial radio access network (EUTRAN) 205. As mentioned above, the user equipment 201 may be any suitable communication device or computational device with communication capabilities.

A mobility management entity (MME) 210 provides control plane functionality, authentication and authorization for the LTE network and gives orders to a serving SAE gateway (SGW) 215.

The SGW 215 is the gateway which terminates the interface towards EUTRAN 205, and towards the packet data network (PDN) 225 comprising the operator's IP services (e.g. IP Multimedia Subsystem (IMS), Primary Synchronization Signal (PSS) etc).

The PGW 220 is the point of exit and entry of traffic for the user equipment 201.

The reference point between the PGW 220 and the PDN 225 is called SGi.

The Serving GPRS Support Node (SGSN) 230 provides connections for global system for mobile communication (GSM) enhanced data rates for global evolution (EDGE) radio access network (GERAN), universal terrestrial radio access network (UTRAN) and Evolved UTRAN (EUTRAN) 3GPP access networks. It performs MBMS bearer service control functions for each user equipment 201, and concentrates all individual users of the same MBMS service on a single MBMS service. The SGSN 230 maintains a single connection with the source of MBMS data.

The policy and charging control function (PCRF) 235 is responsible for Quality of Service (QoS) aspects between the user equipment 201 and the operator's IP services 225.

The home subscriber server (HSS) 240 is connected to the MME 210 and describes the many database functions in the network.

The BM-SC 245 node acts as an MBMS data source, and handles broadcasting and/or multicasting, MBMS of media content supplied from a media content server, not shown. It may serve as an entry point for content provider MBMS transmissions, used to authorize and initiate MBMS bearer services. The BM-SC 245 is a functional entity, which must exist for each MBMS user service.

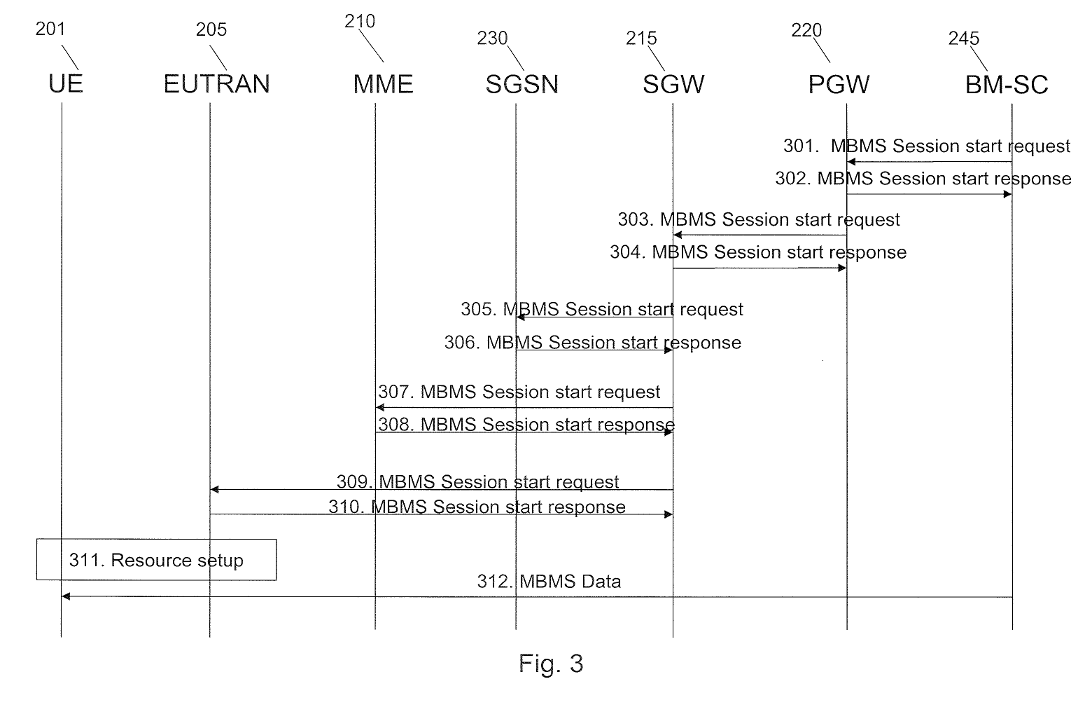

FIG. 3 is a combined flowchart and signaling diagram illustrating an example of a MBMS session start procedure according to embodiments of the present solution. The MBMS session start procedure requests the EUTRAN 205 to notify the user equipment 200 about an upcoming MBMS session. The BM-SC 245 initiates the MBMS session start procedure when it is ready to send data.

The method comprises the following steps:

Step 301

The BM-SC 245 sends an MBMS session start request to the PGW 220. This is a request to activate bearer resources in the network for the transfer of MBMS data and to notify interested user equipments 200 of the start of the transmission. The session start request comprises various MBMS parameters, such as e.g. QoS, MBMS service area, estimated session duration, time to MBMS data transfer etc.

After sending the session start request message the BM-SC 245 waits for a configurable delay (time to MBMS data transfer) before sending MBMS data. This delay should be long enough to avoid buffering of MBMS data in entities other than the BM-SC 245, i.e. the delay should allow the network to perform all procedures required to enable MBMS data transfer before the BM-SC 245 sends MBMS data. The delay may be in the region of multiple seconds or tens of seconds.

Step 302

The PGW 220 sends an MBMS session start response.

Step 303

The PGW 220 forwards the MBMS session start request to the SGW 215.

The forwarded session start request may comprise the received session request and gateway processing information. There are different interfaces and protocols between the PGW 220 and the SGW compared to between the BM-SC 245 and the PGW 220. Due to different interfaces and protocols the PGW 220 may do some processing of the received session request, and may compose a “new” message with bits and bytes from the processing, i.e. gateway processing information.

Step 304

The SGW 215 sends an MBMS session start response to the PGW 220.

Step 305

This is an optional step where the system is a UTRAN or 2G system. The SGW 215 may forward the MBMS session start request to the SGSN 230.

Also here, due to different interfaces and protocols the SGW 215 may do some processing and then compose a “new” message with bits and bytes from the processing, i.e. gateway processing information. The forwarded session start request therefore may comprise both the received session start request and gateway processing information.

Step 306

This is an optional step where the system is a UTRAN or 2G system. The SGSN 230 may send an MBMS session start response to the SGW 215.

Step 307

This is an optional step. The SGW 215 may forward the MBMS session start request to the MME 210.

Also here, due to different interfaces and protocols the SGW 215 may do some processing and then compose a “new” message with bits and bytes from the processing, i.e. gateway processing information. The forwarded session start request therefore may comprise both the received session start request and gateway processing information.

Step 308

This is an optional step. The MME 210 may send an MBMS session start response back to the SGW 215.

Step 309

The SGW 215 forwards the MBMS session start request to the EUTRAN 205.

Also here, due to different interfaces and protocols the SGW 215 may do some processing and then compose a “new” message with bits and bytes from the processing, i.e. gateway processing information. The forwarded session start request therefore may comprise both the received session start request and gateway processing information.

Step 310

The EUTRAN 205 sends an MBMS session start response to the SGW 215.

Step 311

The necessary radio resources are setup in the user equipment 200 and the EUTRAN 205 for the transmission of MBMS data in the MBMS session.

Step 312

The BM-SC 245 sends MBMS data to the user equipment 200. The MBMS data may be different types of data, such as e.g. streaming data (video, audio, speech, etc.) but also file data (binary data, image, text, etc.).

Even though the gateways in FIG. 3 are shown as PGW 220 and SGW 215, other core network gateways or other network units may implement MBMS.

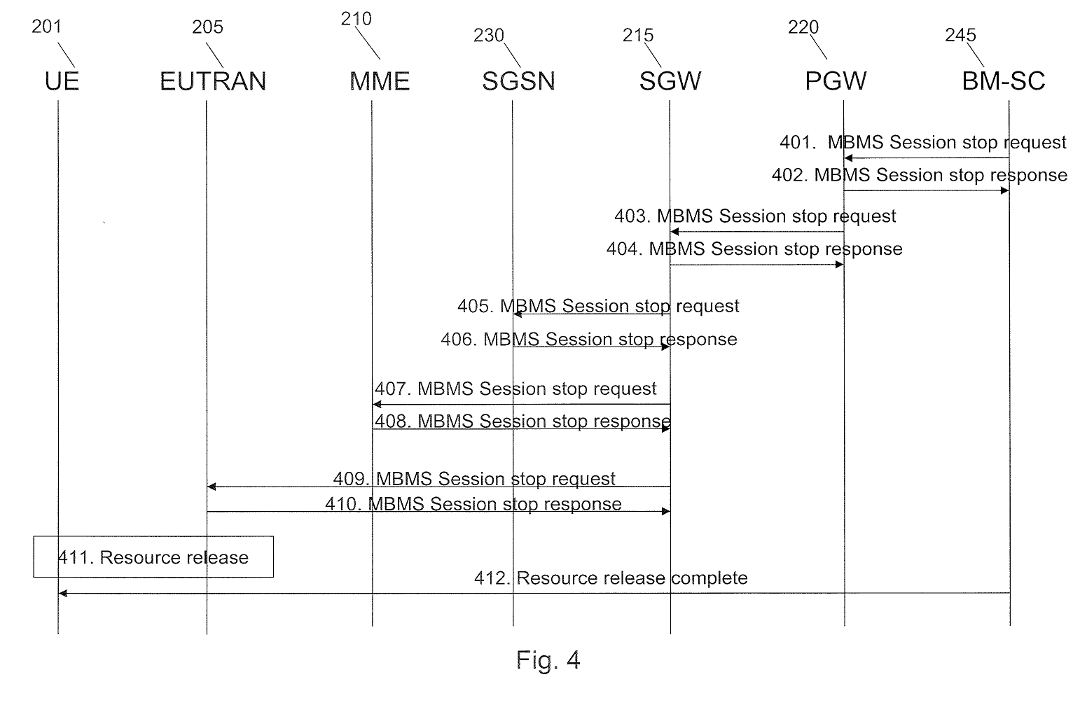

FIG. 4 is a combined flowchart and signaling diagram illustrating a MBMS session stop procedure. The MBMS session stop procedure requests the EUTRAN 205 to notify the user equipment 200 about the end of a MBMS session. The MBMS session is typically terminated when there is no more MBMS data expected to be transmitted for a sufficiently long period of time to justify a release of bearer plane resources in the network. The MGMS session stop procedure comprises the following steps:

Step 401

The BM-SC 245 sends an MBMS session stop request to the PGW 220.

Step 402

The PGW 220 forwards the session stop response to the BM-SC 245.

Step 403

The PGW 220 forwards the MBMS session stop request to the SGW 215.

The forwarded session stop request may comprise the received session stop request and gateway processing information. There are different interfaces and protocols between the PGW 220 and the SGW 215 compared to between the BM-SC 245 and the PGW 220. The different interfaces and protocols makes it necessary for the PGW 220 to maybe do some processing and then compose a “new” message with bits and bytes from the processing, i.e. gateway processing information.

Step 404

The SGW 215 sends an MBMS session stop response to the PGW 220.

Step 405

This is an optional step where the system is a UTRAN or 2G system. The SGW 215 may forward the MBMS session stop request to the SGSN 230.

The forwarded session stop request may comprise the received session stop request and gateway processing information. There are different interfaces and protocols between the PGW 220 and the SGW 215 compared to between the BM-SC 245 and the PGW 220. The different interfaces and protocols makes it necessary for the PGW 220 to maybe do some processing and then compose a “new” message with bits and bytes from the processing, i.e. gateway processing information.

Step 406

This is an optional step where the system is a UTRAN or 2G system. The SGSN 230 may send an MBMS session stop response back to the SGW 215.

Step 407

This is an optional step. The SGW 215 may forward the MBMS session stop request to the MME 210.

Also here, different interfaces and protocols makes it necessary for the SGW 215 to maybe do some processing and then compose a “new” message with bits and bytes from the processing, i.e. gateway processing information. The forwarded session stop request therefore may comprise both the received session stop request and gateway processing information.

Step 408

This is an optional step. The MME 210 may send an MBMS session stop response to the SGW 215.

Step 409

The SGW 215 may forward the MBMS session stop request to the EUTRAN 205.

Also here, different interfaces and protocols makes it necessary for the SGW 215 to maybe do some processing and then compose a “new” message with bits and bytes from the processing, i.e. gateway processing information. The forwarded session stop request therefore may comprise both the received session stop request and gateway processing information.

Step 410

The EUTRAN 205 sends an MBMS session stop response back to the SGW 215.

Step 411

The radio resources utilized in the MBMS session are released and the session is terminated.

Step 412

This is an optional step. The EUTRAN 205 may send a resource release complete message to the BM-SC 245.

It is shown how MBMS information may be sent from the PGW 220 to the SGW 215 at MBMS session start and MBMS session stop for a proxy mobile internet protocol (PMIP) based S5/S8 interface. However, other entities, such as e.g. GGSN (gateway GPRS support node) or MBMS GW (MBMS gateway), can also implement MBMS instead of the PGW 220 and the SGW 215.

The present solution proposes a mechanism for providing the MBMS service in a 3GPP Release 9 LTE/EPC network to user equipments 200 that use the LTE access technology in case PMIP is used in the core network. One alternative for how the MBMS will be defined in LTE/EPC is to include MBMS in LTE/EPC by mimicking in LTE/EPC how MBMS was done in GPRS. This includes adding MBMS functionality to existing EPC nodes PGW 220, SGW 215 and Mobility Management Entity MME 210, in analogy to how it is included in the GPRS nodes (GGSN, SGSN). With this alternative the BM-SC 245 is connected to PGW 220 via the SGi reference point. MBMS specific messages and information elements are added to GTPv2, i.e. MBMS session start and session stop messages are sent from the BM-SC 245 to the PGW 220, to the SGW 215 and to the MME 210.

There are two variants of this second alternative:
a) where both user plane and control plane are handled in the same way i.e. along the same paths
   or
b) where only the control plane is handled this way and where the user plane instead is designed as a separate path using IP Multicast.

The present solution is applicable both for variant a) and b).

In EPC it is possible to use PMIP in the S5/S8 reference point as an alternative to GTP. When using PMIP, it is not possible to send MBMS specific session management messages. Also PMIP messages proxy binding update (PBU)/proxy binding acknowledgement (PBA) are sent uplink from the mobile access gateway (MAG)/SGW to the PGW. This is not according to the MBMS model, since MBMS session start and stop messages must be sent from the PGW 220 to the SGW 215 as it is done with GTP.

For MBMS the signaling for broadcast functionality needs the messages MBMS session start request/response and MBMS session stop request/response. These messages are triggered from the BM-SC 245 sending the corresponding messages to the PGW 220. The S5 session start and stop requests need to be sent from the PGW 220 to the SGW 215 and a response is sent back. However, as mentioned above, existing PMIP request/response messages are triggered from the mobile access gateway (MAG), i.e. from the SGW 215, and not from the PGW 220. The PBU is first sent from the SGW 215 and the PBA is sent back from the PGW 220. Therefore the PBU/PBA messages are not suitable for MBMS signaling. Several implementations are possible for providing MBMS on the S5/S8 interface:
1. Use other existing messages.
2. Use other existing IETF based protocol.

Method 1:

It is specified that a Binding Revocation Indication (BRI)/Binding Revocation Acknowledgement (BRA) message exchange shall be used to revoke a PDN connection. The BRI message is triggered and sent from the PGW 220 to the SGW 215, and a reply BRA message is sent back from the SGW 215 to the PGW 220. These messages have the correct exchange sequence order and may be used for MBMS session start. It requires that a 3GPP specific indication is included such that the protocol has a 3GPP specific behavior.

A new vendor specific MBMS information element is defined and included. The existence of this field indicates that the BRI/BRA messages are used in a 3GPP specific way to exchange MBMS session start/stop messages.

This new MBMS field may be an MBMS container information element, which includes all MBMS related info, such as fore example session IDs, geographic information, session repetitions and duration, etc. This new MBMS field is information element 2 shown in table 1 below.

TABLE 1
3GPP Vendor-Specific Mobility Option Subtypes

| Information | |
|---|---|
| element | IE Description |
| 1 | 3GPP PCO data, in the format from 3GPP |
| | TS 24.008 [16] section 10.5.6. |
| 2 | 3GPP MBMS data container, in the format |
| | from 3GPP TS 29.060 [X] |

Alternatively, a number of subtypes may be added, that each include information corresponding to GTP information elements for MBMS. These subtypes may e.g. be Temporary Mobile Group Identity (TMGI), MBMS Session Duration, MBMS Service Area, MBMS Session Identifier, MBMS 2G/3G Indicator, MBMS Session Repetition Number, MBMS Time To Data Transfer etc. These subtypes are shown in information element 2-8 in table 2 below.

TABLE 2
3GPP Vendor-Specific Mobility Option Subtypes

| Information | |
|---|---|
| element | IE Description |
| 1 | 3GPP PCO data, in the format from 3GPP TS 24.008 |
| | [16] section 10.5.6. |
| 2 | Temporary Mobile Group Identity (TMGI), in the |
| | format from 3GPP TS 29.060 [X] |
| 3 | MBMS Session Duration, in the format from 3GPP TS |
| | 29.060 [X] |
| 4 | MBMS Service Area, in the format from 3GPP TS |
| | 29.060 [X] |
| 5 | MBMS Session Identifier, in the format from 3GPP |
| | TS 29.060 [X] |
| 6 | MBMS 2G/3G Indicator, in the format from 3GPP TS |
| | 29.060 [X] |
| 7 | MBMS Session Repetition Number, in the format |
| | from 3GPP TS 29.060 [X] |
| 8 | MBMS Time To Data Transfer, in the format from |
| | 3GPP TS 29.060 [X] |

In either case the BRI/BRA exchange will include the necessary info and trigger the SGW 215 to do MBMS session start/stop downstream.

Method 2

It may also be possible to use another existing IETF protocol, such as an AAA (authentication, authorization and accounting) protocol. The AAA protocol may be used between the BM-SC 245 and the PGW 220, and may therefore already be implemented in the PGW 220. The same messages as is used in the Gi/SGi interface may be used, i.e. the PGW 220 sends a resource allocation request (RAR) message to the SGW 215 for MBMS session start request, and the SGW 215 responds with the resource allocation answer (RAA) message, and analogous for session stop. The information elements in the messages may be slightly altered to fit the S5/S8 interface. An example of a computer networking protocol for AAA that may be used is e.g. the diameter or radius protocol.

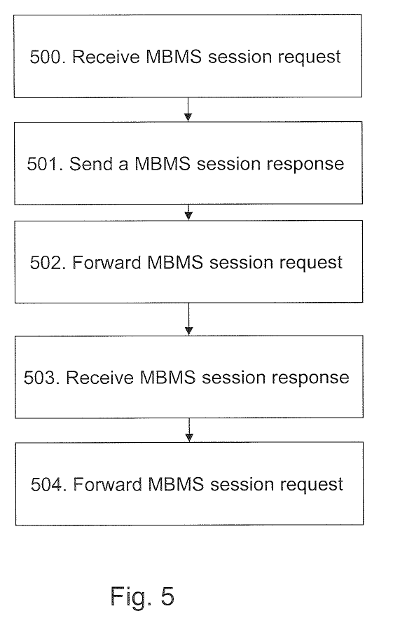

The method described above will now be described seen from the perspective of the first core network gateway 220. FIG. 5 is a flowchart describing the present method in the first core network gateway 220 for providing MBMS in a wireless communication network 100. The network 100 comprises a BM-SC node 245 arranged to be connected to the first core network gateway 220. The network 100 further comprises a second core network gateway 215 arranged to be connected to the first core network gateway 220. The wireless communication network 100 may be a LTE/EPC network.

The method comprises the further steps to be performed in the first core network gateway 220:

Step 500

The first core network gateway 220 receives a MBMS session request from the BM-SC node 245.

Optionally, the first core network gateway may be a PGW 220.

Optionally, an AAA protocol may be implemented in the first core network gateway 220 and used in an interface between the BM-SC node 245 and the first core network gateway 220.

Step 501

The first core network gateway 220 sends a MBMS session response back to the BM-SC node 245.

Optionally, the session request may be a session start request and the session response is a session start response.

Optionally, the session request may be a session stop request and the session response is a session stop response.

Optionally, the MBMS session start request may be a BRI message and the MBMS session start response may be a BRA message.

Optionally, the AAA protocol may be implemented in the second core network gateway 215.

Optionally, the AAA protocol may be a diameter protocol.

Optionally, the MBMS session start request may be a RAR message and the MBMS session start response may be a RAA message.

Step 502

The first core network gateway 220 forwards the MBMS session request message to the second core network gateway 215.

Optionally, the forwarded request message may comprise the received session request and gateway information.

Optionally, the second core network gateway 215 may be a SGW.

Optionally, an interface between the first core network gateway 220 and the second core network gateway 215 may be a PMIP based protocol.

Step 503

The first core network gateway 200 receives an MBMS session response message from the second core network gateway 215. The MBMS session request and response comprises an information field adapted to MBMS.

Optionally, the information field may comprise an information element comprising MBMS related information.

Optionally, the information field may comprise at least two information elements each comprising MBMS related information.

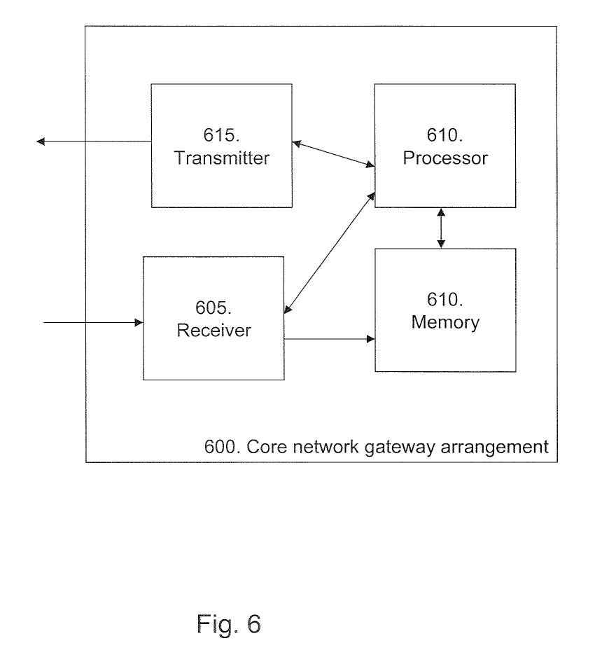

To perform the method steps shown in FIG. 5 for providing MBMS in a wireless communication network 100 comprises a first core network gateway arrangement 600 as shown in FIG. 6. The network 100 comprises a BM-SC 245 node arranged to be connected to the first core network gateway 220. The network 100 further comprises a second core network gateway 215 arranged to be connected to the first core network gateway 220. The first core network gateway arrangement 600 comprises a receiver 605 arranged to receive a MBMS session request from the BM-SC node 245. A processor 610 composes a MBMS session response message and a transmitter 615 is arranged to send the MBMS session response message to the BM-SC node 245. The processor 610 is arranged to process the session request message, and the transmitter 615 is arranged to forward the request to the second core network gateway 215. The receiver 605 is arranged to receive a MBMS session response message from the second core network gateway 215. The MBMS session request and response comprises an information field adapted to MBMS.

The present mechanism for providing MBMS in a wireless communication network 100 may be implemented through one or more processors, such as a processor 610 in the first core network gateway arrangement 600 depicted in FIG. 6, together with computer program code for performing the functions of the present solution. The program code mentioned above may also be provided as a computer program product, for instance in the form of a data carrier carrying computer program code for performing the present solution when being loaded into the first core network gateway 220 and/or other core network gateways 215. One such carrier may be in the form of a CD ROM disc. It is however feasible with other data carriers such as a memory stick. The computer program code may furthermore be provided as pure program code on a server and downloaded to the core network gateway 220 and/or other core network gateways 215 remotely using the network 100 as carrier.

The MBMS payload path (user plane) may be simply analogous to the GTP version. The SGW 215 may in the response to the PGW 220 indicate a SGW 215 address for user data and a down link tunnel identifier a Generic Routing Encapsulation (GRE) key. The GRE key corresponds to the Tunnel Endpoint Identifier (TEID) used in GTP. An alternative method for payload transmission may be to use IP Multicast as a transport in the core and access network. Such a method for the MBMS payload path would also be aligned with the current invention, which is basically related to the control plane only.

The solution described above for doing MBMS session start/stop signaling over a PMIP based S5/S8 may also be applied on a PMIP based S2a interface towards Code Division Multiple Access (CDMA). The S2a interface provides the user plane with control and mobility support between non-3GPP IP access and a gateway. S2a is based on PMIP. That is, a PMIP interface between the PGW 220 and the Packet Data Serving Node (PDSN) node (not shown) in the High Rate Packet Data (HRPD)/CDMA 2000 network. That would enable MBMS also in CDMA access networks.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, and that several “means”, “devices”, and “units” may be represented by the same item of hardware.

The present invention is not limited to the above described preferred embodiments. Various alternatives, modifications and equivalents may be used. Therefore, the above embodiments should not be taken as limiting the scope of the invention, which is defined by the appending claims.

Summarized, the present solution integrates MBMS and SAE LTE/EPC in a simple, quick and cost efficient way. The MBMS functionality is available also in the case that S5/S8 interfaces are IETF based. The solution supports MBMS based services such as Mobile TV and broadcast in any future GTP or IETF based LTE/EPC network. Specifically, the problem of session management for broadcast and multicast is solved when PMIP mobility protocol is used in the network. The strength of the solution presented is its cost effectiveness. It is based on reuse of release 7 functionality in existing nodes. No new infrastructure investments are needed. It is obvious that implementing a parallel MBMS architecture would be more costly without any comparable benefits. Also the time to market and the standardization effort needed is unparalleled by overlay architecture solutions.

1-15. (canceled)

16. A method in a first core network gateway for providing multimedia broadcast multicast service (MBMS) in a wireless communication network, wherein the network includes a broadcast multicast service center (BM-SC) node connected to the first core network gateway and a second core network gateway connected to the first core network gateway over an S5/S8 interface, said method comprising the steps of:
receiving an MBMS session request from the BM-SC node;
sending an MBMS session response to the BM-SC node;
forwarding the MBMS session request message to the second core network gateway; and,
receiving an MBMS session response message from the second core network gateway;
wherein the MBMS session request and response messages each comprise an information field adapted to MBMS.

17. The method according to claim 16, wherein the session request is a session start request and the session response is a session start response.

18. The method according to claim 16, wherein the session request is a session stop request and the session response is a session stop response.

19. The method according to claim 16, wherein the forwarded request message comprises the received session request and gateway information.

20. The method according to claim 16, wherein the wireless communication network is a long term evolution (LTE) evolved packet core (EPC) network.

21. The method according to claim 16, wherein the first core network gateway is a packet data network gateway (PGW).

22. The method according to claim 16, wherein the second core network gateway is a serving gateway (SGW).

23. The method according to claim 16, wherein an interface between the first core network gateway and the second core network gateway is a proxy mobile internet protocol (PMIP) based protocol.

24. The method according to claim 16, wherein the MBMS session start request is a binding revocation indication (BRI) message and the MBMS session start response is a binding revocation acknowledgement (BRA) message.

25. The method according to claim 16, wherein the information field comprises at least one information element comprising MBMS related information.

26. The method according to claim 16, wherein an authentication, authorization and accounting (AAA) protocol is implemented in the first core network gateway and used in an interface between the BM-SC node and the first core network gateway.

27. The method according to claim 26, wherein, the AAA protocol is implemented in the second core network gateway.

28. The method according to claim 27, wherein the AAA protocol is a diameter protocol.

29. The method according to claim 26, wherein the MBMS session start request is a resource allocation request (RAR) message and the MBMS session start response is a resource allocation answer (RAA) message.

30. A core network gateway for providing multimedia broadcast multicast service (MBMS) in a wireless communication network, wherein the network includes a broadcast multicast service center (BM-SC) node connected to the first core network gateway and a second core network gateway connected to the first core network gateway, the core network gateway comprising:
a receiver configured to receive an MBMS session request from the BM-SC node;
a transmitter configured to send a MBMS session response to the BM-SC node;
a transmitter configured to forward the MBMS session request message to the second core network gateway over an S5/S8 interface; and,
a receiver configured to receive an MBMS session response message from the second core network gateway;
wherein the MBMS session request and response messages each comprise an information field adapted to MBMS.
